(19) United States
(12) Patent Application Publication
(10) Pub. No.: US 2013/0024065 A1
(43) Pub. Date: Jan. 24, 2013

(54) Autonomous Electronic Device and Method of Controlling Motion of the Autonomous Electronic Device Thereof

(71) Applicants: Hung-Chih Chiu, Zhonghe City (TW); Chung-Hsien Chuang, Zhonghe City (TW); Chi-Shing Lin, Zhonghe City (TW); Harry Chia-Hung Hsu, Zhonghe City (TW)

(72) Inventors: Hung-Chih Chiu, Zhonghe City (TW); Chung-Hsien Chuang, Zhonghe City (TW); Chi-Shing Lin, Zhonghe City (TW); Harry Chia-Hung Hsu, Zhonghe City (TW)

(21) Appl. No.: 13/283,678

(22) Filed: Oct. 28, 2011

(30) Foreign Application Priority Data
Jul. 22, 2011 (TW) 100126039

(51) Int. Cl. G05D 1/00

(52) U.S. Cl. 701/26

(57) ABSTRACT

An autonomous electronic device and a method of controlling the motion of the autonomous electronic device thereof are disclosed. The autonomous electronic device includes a motor, a wheel, a processing module, a motor controlling module, and a motion sensor module. The motor is used for driving the wheel. The motor controlling module is used for controlling the motor. The motion sensor module is used for generating a sensing signal according to surrounding conditions encountered by the autonomous electronic device and transferring the signal to the processing module, wherein when the sensing signal is an abnormal movement signal, the processing module controls the motor to adapt to the surrounding conditions via the motor controlling module according to the abnormal movement signal.

### BACKGROUND OF THE INVENTION

1. Field of the Invention

The present invention relates to an autonomous electronic device and a method of controlling the motion of the autonomous electronic device thereof; more particularly, the present invention relates to an autonomous electronic device that uses a motion sensor module to detect the surrounding conditions and a method of controlling the motion of the autonomous electronic device thereof.

2. Description of the Related Art

As technology develops, autonomous electronic devices, also known as robots, are applied widely to automatically execute cleaning work. However, in the prior art, to prevent the autonomous electronic device from hitting an obstacle or a wall, a contact sensor or a non-contact sensor is located on the autonomous electronic device. The non-contact sensor uses infrared rays or laser to transmit signals to detect the distance from the obstacle to itself. In order to reduce the blind spots in its detection ability, the autonomous electronic device of the prior art comprises a contact sensor, such as a bumper. When the bumper, which is located on the autonomous electronic device, hits an obstacle, the autonomous electronic device will automatically stop or change its direction of movement.

However, to allow the autonomous electronic device of the prior art to work better, the autonomous electronic device must comprise both a contact sensor and a non-contact sensor, which adds difficulty to design the device and increases the manufacturing cost. On the other hand, there is a height limit for the contact sensor and the non-contact sensor of the autonomous electronic device in the prior art; for example, if the height of obstacle is lower than the main body of the autonomous electronic device, or the obstacle is higher than the height of the bumper, the autonomous electronic device of the prior art may fail to avoid the obstacle. Furthermore, while moving across an uneven surface, the autonomous electronic device of the prior art cannot adjust its movement immediately according to surrounding conditions.

Therefore, there is a need to provide a new autonomous electronic device and a method of controlling the motion of the autonomous electronic device thereof, to solve the disadvantages of the prior art.

### SUMMARY OF THE INVENTION

It is an object of the present invention to provide an autonomous electronic device that comprises a motion sensor module for detecting the surrounding conditions.

It is another object of the present invention to provide a method of controlling the motion of the autonomous electronic device.

To achieve the abovementioned object, the autonomous electronic device of the present invention includes a motor, a wheel, a processing module, a motor controlling module, and a motion sensor module. The motor connects to the wheel for driving the wheel. The motor controlling module electrically connects to the motor for controlling the motor. The motion sensor module is used for generating a sensing signal according to the surrounding conditions sensed by the autonomous electronic device. The processing module electrically connects to the motor controlling module and to the motion sensor module for receiving the sensing signal; wherein when the sensing signal is an abnormal movement signal, the processing module controls the motor via the motor controlling module in response to the abnormal movement signal and further adjusts the wheel to adapt to the surrounding conditions.

The method of controlling the motion of the autonomous electronic device comprises the follow steps: detecting a sensing signal via a motion sensor module according to a surrounding condition detected by the autonomous electronic device; determining whether the sensing signal is an abnormal movement signal; and if yes, controlling the motor according to the abnormal movement signal and further adjusting the wheel to adapt to the surrounding conditions.

### BRIEF DESCRIPTION OF THE DRAWINGS

FIG. 1A illustrates a system structure drawing of the autonomous electronic device according to the first embodiment of the present invention.

FIG. 1B illustrates a system structure drawing of the autonomous electronic device according to the second embodiment of the present invention.

FIG. 2 illustrates an outward appearance schematic drawing of the autonomous electronic device according to one embodiment of the present invention.

FIG. 3 illustrates a flowchart drawing of the method of controlling the motion of the autonomous electronic device of the present invention.

FIG. 4 illustrates a flowchart drawing of the method for adjusting the motor of the autonomous electronic device according to the first embodiment of the present invention.

FIG. 5 illustrates a flowchart drawing of the method for adjusting the motor of the autonomous electronic device according to the second embodiment of the present invention.

FIG. 6 illustrates a flowchart drawing of the method for adjusting the motor of the autonomous electronic device according to the third embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

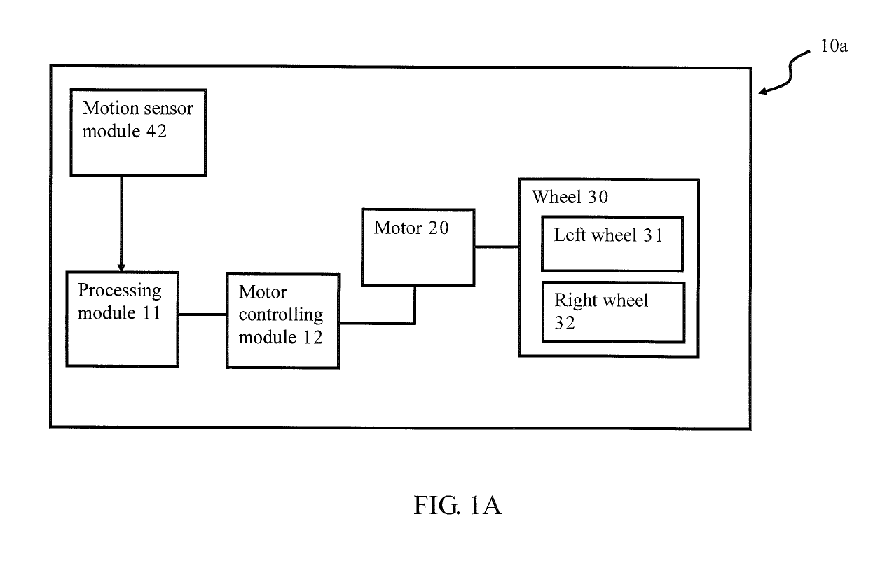

Please refer to FIG. 1A, which illustrates a system structure drawing of the autonomous electronic device according to the first embodiment of the present invention.

In the first embodiment of the present invention, the autonomous electronic device 10a is an automatic cleaning robot, but the present invention is not limited to that application. The autonomous electronic device 10a comprises a processing module 11, a motor controlling module 12, a motor 20, a wheel 30, and a motion sensor module 42. The processing module 11 and the motor controlling module 12 can be software, firmware, hardware, or a firmware with hardware, but the present invention is not limited to that design. The processing module 11 is used for controlling the function within the autonomous electronic device 10a. The motor controlling module 12 is connected electrically to the processing module 11, which controls the motor 20 via the motor controlling module 12. The motor 20 connected to the wheel 30 is used for controlling the rotation speed and direction. In this embodiment, the wheel 30 comprises the left wheel 31 and the right wheel 32, but the present invention is not limited to two wheels.

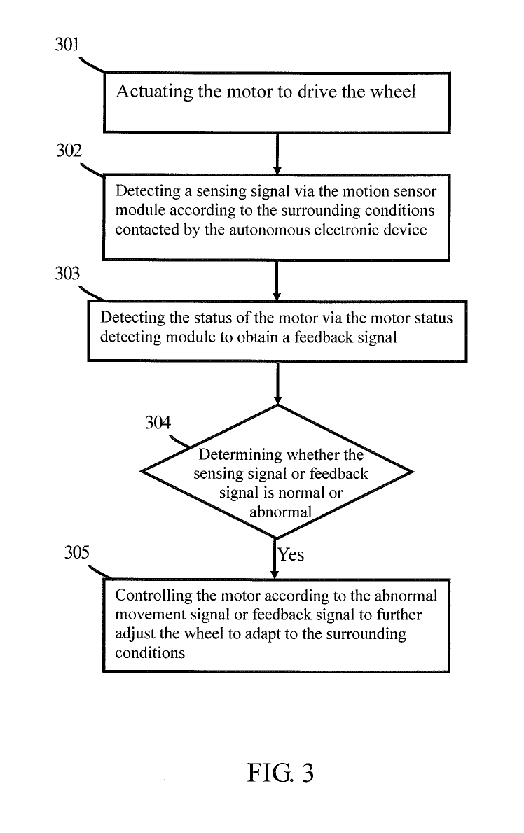

The motion sensor module 42, connected electrically to the processing module 11, is used for generating a sensing signal according to a surrounding condition encountered by the autonomous electronic device 10a, and then determining whether the sensing signal is over a threshold to determine whether the signal is a normal or an abnormal movement signal; or transferring the signal to the processing module 11 to determine whether the signal is a normal or an abnormal movement signal. The abnormal movement signal is generated by the motion sensor module 42 based on the surrounding conditions and the surface under specific terms contacted by the autonomous electronic device 10a to generate the signal. For example, when the autonomous electronic device 10a encounters uneven ground or an obstacle, the abnormal signal will be generated. The details of the embodiment for this condition will be described in FIGS. 4-6 later; there is no need here for further description.

In the present embodiment, the motion sensor module 42 is an accelerometer (such as G-sensor) used for detecting the sensing signal of the horizontal axis (such as the X/Y-axis) and vertical axis (such as the Z-axis) to sense abnormal movement signals of the horizontal and/or vertical axis when the autonomous electronic device 10a encounters an external condition. However, the present invention is not limited to this application. The motion sensor module 42 can be a gyro sensor, an e-compass, a barometer, or similar devices.

When the motion sensor module 42 or the processing module 11 determines the sensing signal is an abnormal movement signal, the processing module 11 can control the motor 20 in response to the abnormal signal to further adjust the rotation speed and direction of the wheel 30. The method of adjustment will be described in detail later; there is no need here for further description.

Please refer to FIG. 1B, which illustrates a system structure drawing of the autonomous electronic device according to the second embodiment of the present invention.

The second embodiment of the present invention is the best embodiment of the present invention. In the second embodiment of the present invention, the autonomous electronic device 10b includes a processing module 11, a motor controlling module 12, a motor 20, a wheel 30, a motor status detecting module 41, and a motion sensor module 42. The processing module 11 is used for controlling the function within the autonomous electronic device 10b. The motor controlling module 12 is connected electrically to the processing module 11, the processing module 11 controls the motor 20 via the motor controlling module 12. The motor 20, connected to the wheel 30, is used for controlling the rotation speed and direction.

The autonomous electronic device 10b comprises both the motor status detecting module 41 and the motion sensor module 42. The motor status detecting module 41, which is connected electrically to the motor 20 and the motor controlling module 12, is used for detecting the status of the motor 20, and to obtain a feedback signal to transfer to the motor controlling module 12 and the processing module 11, to determine whether the signal is over a threshold. In one embodiment of the present invention, the motor status detecting module 41 is an electric current detecting module used for detecting the electric current value of the motor 20; however, the present invention is not limited to the design. Therefore, the processing module 11 can control the motor 20 based on the feedback signal when the feedback signal is abnormal and further adjust the rotation speed and direction of the wheel 30 to adapt to the surrounding conditions. The method of adjustment will be described in detail later; there is no need here for further description.

The motion sensor module 42, connected electrically to the processing module 11, is used for detecting the sensing signal according to the surrounding conditions encountered by the autonomous electronic device 10b, then determining whether the signal is a normal or an abnormal movement signal, and transferring the information to the processing module 11. The operations of the processing module 11 will be described in detail later; there is no need here for further description.

Therefore, the processing module 11 can control the motor 20 accurately, based on the feedback signal or the abnormal movement signal, and further adjust the rotation speed and direction of the wheel 30 to adapt to surrounding conditions.

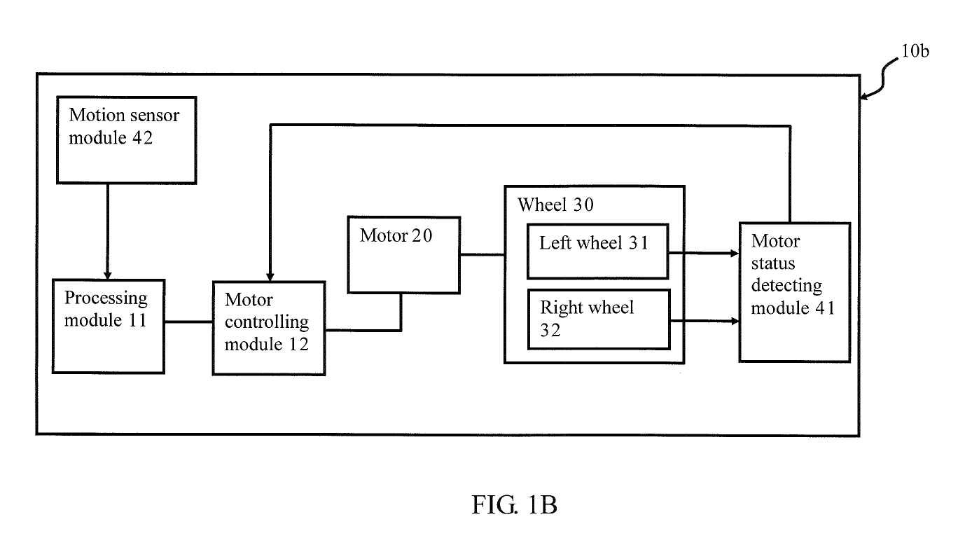

For the location of the motion sensor module 42, please refer to FIG. 2, which illustrates an outward appearance schematic drawing of the autonomous electronic device according to one embodiment of the present invention.

The motion sensor module 42 is located in a place where the motion sensor module 42 can detect the greatest change in acceleration of the horizontal axis. In one embodiment of the present invention, the left wheel 31 and the right wheel 32 are respectively located on the left and right sides of the autonomous electronic device 10b. Therefore, the motion sensor module 42 is substantially located on the edge of the autonomous electronic device 10b, and also substantially located on the central extension line L, the central extension line L is equidistant from the left wheel 31 and the right wheel 32, to achieve the best detecting effect.

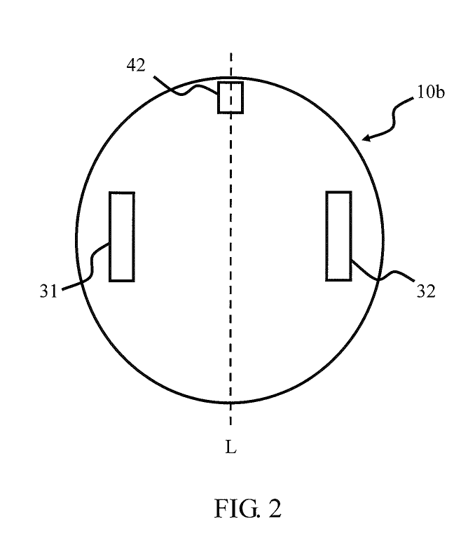

Please refer to FIG. 3, which illustrates a flowchart drawing of the method of controlling a motion of the autonomous electronic device of the present invention. It should be noted that the example below uses the autonomous electronic device 10b to describe the method of controlling the motion of the autonomous electronic device of the present invention, but the method is not limited to the autonomous electronic device 10b.

First the method begins with step 301: Actuating the motor to drive the wheel.

First, the autonomous electronic device 10b actuates the motor 20 to rotate the wheel 30, such that the autonomous electronic device 10b can move by itself.

Then the method proceeds to step 302: detecting a sensing signal via the motion sensor module according to the surrounding conditions encountered by the autonomous electronic device.

While the wheel 30 rotates, the motion sensor module 42 immediately detects the sensing signal according to the surroundings and ground condition encountered by the autonomous electronic device 10b. In one embodiment of the present invention, the motion sensor module 42 is an accelerometer, such that it can detect acceleration on the horizontal axis and vertical axis for the autonomous electronic device 10b. Therefore, according to the surrounding conditions encountered by the autonomous electronic device 10b, the sensing signal can be detected to further obtain the sensing signal of the horizontal axis and vertical axis.

At the same time, the method proceeds to step 303: Detecting the status of the motor via the motor status detecting module to obtain a feedback signal.

While actuating the motor 20, the motor status detecting module 41 immediately detects the status of the motor 20 to obtain the feedback signal and transfer it to the motor controlling module 12. It should be noted that the motor status detecting module 41 is an electric current detecting module in the example below; however, this invention is not limited to that design. The electric current value changes according to different conditions; for example, when the autonomous electronic device 10c encounters an obstacle, resistance occurs, such that the electric current value of the motor 20 will increase. Therefore, the autonomous electronic device 10b can detect abnormal conditions by detecting the feedback signal of the electric current value of the motor 20.

Then the method proceeds to step 304: Determining whether the sensing signal or feedback signal is normal or abnormal.

Then the motion sensor module 42 and the processing module 11 determine whether the detecting signal is normal or abnormal. For example, the motion sensor module 42 and the processing module 11 determine if the signal is over a threshold to determine whether the signal is normal or not. In the meantime, the motor status detecting module 41 or the processing module 11 also determine if the signal is over a threshold to determine whether the status of the autonomous electronic device 10b is normal or not.

If the sensing signal or feedback signal is abnormal, then the method proceeds to step 305: controlling the motor according to the abnormal movement signal or feedback signal to further adjust the wheel to adapt to the surrounding conditions.

Depending on the abnormal movement signal or feedback signal, the processing module 11 determines to keep or change the movement of the autonomous electronic device 10b, which means controlling the motor 20 via the motor controlling module 12, and further adjusting the rotation speed and direction of the wheel 30, such that the autonomous electronic device 10b can adapt to the surrounding conditions and surface.

It should be noted that it is not necessary to actuate the autonomous electronic device 10b before executing the motion sensing method, which means that step 301 does not necessarily have to be executed previously in the present invention; the autonomous electronic device 10b can still detect abnormalities in the static status. Meanwhile, if the motor status detecting module 41 is not located on the autonomous electronic device 10b, then the autonomous electronic device 10b will not execute step 303. Thus, if the motion sensor module 42 is not located on the autonomous electronic device 10b, then the autonomous electronic device 10b may not execute step 302.

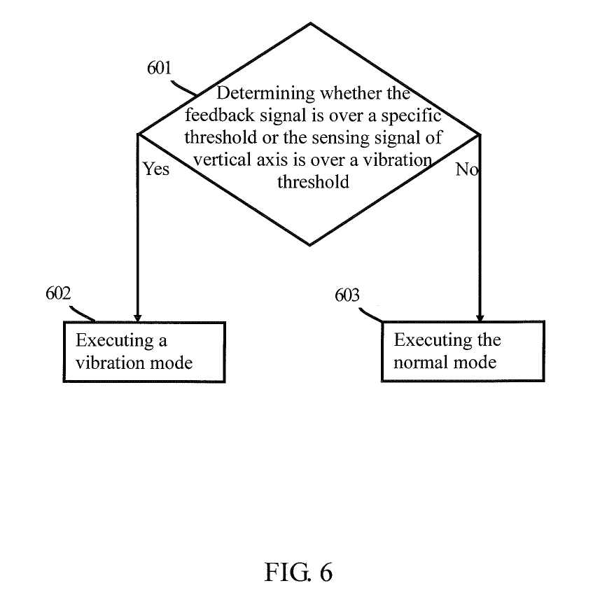

For the above steps 304˜305 and the embodiment of the processing module 11 to control the motor 20, please refer to FIG. 4, which illustrates a flowchart drawing of the method for adjusting the motor of the autonomous electronic device according to the first embodiment of the present invention. To be noted is that the embodiments and step sequence below for FIG. 4˜FIG. 6 are only examples, and that the present invention is not limited to those designs.

First the method proceeds to step 401: Determining whether the sensing signal of the horizontal axis is less than the moving threshold for a specific period of time.

According to the sensing signal from the motion sensor module 42, the processing module 11 determines if the sensing signal of the horizontal axis is less than the moving threshold for a specific period of time. The moving threshold is the acceleration of the autonomous electronic device 10b in normal movement, and the specific time can be one second, but the present invention is not limited to these settings. If the horizontal axis acceleration of the autonomous electronic device 10b is less than the moving threshold for a period of time, which does not coincide with the normal movement feature of the autonomous electronic device 10b, it can thus be determined that the autonomous electronic device 10b has hit an obstacle and cannot move normally.

If the sensing signal of the horizontal axis is less than the moving threshold for a period of time, then the processing module 11 executes step 402: Executing an obstacle mode.

The sensing signal of the horizontal axis is taken as the abnormal movement signal of the obstacle in the condition; therefore, the processing module 11 executes an obstacle mode of the motor 20. For example, the processing module 11 can control the motor 20 to make the autonomous electronic device 10b go backwards and turn around to avoid the obstacle. Alternatively, the processing module 11 can determine if it is impossible to avoid the obstacle; if so, the processing module 11 can turn off the motor 20 to save power. Therefore, the autonomous electronic device 10b of the present invention can adjust to the surrounding conditions and is not limited to the height of the obstacle. If the sensing signal of the horizontal axis is not less than the moving threshold, then the processing module 11 executes step 403: Executing a normal mode.

If the sensing signal of the horizontal axis is a normal signal, the processing module 11 determines that the autonomous electronic device 10b has not hit an obstacle and generated the abnormal movement signal; then the autonomous electronic device 10b executes the normal mode to move normally.

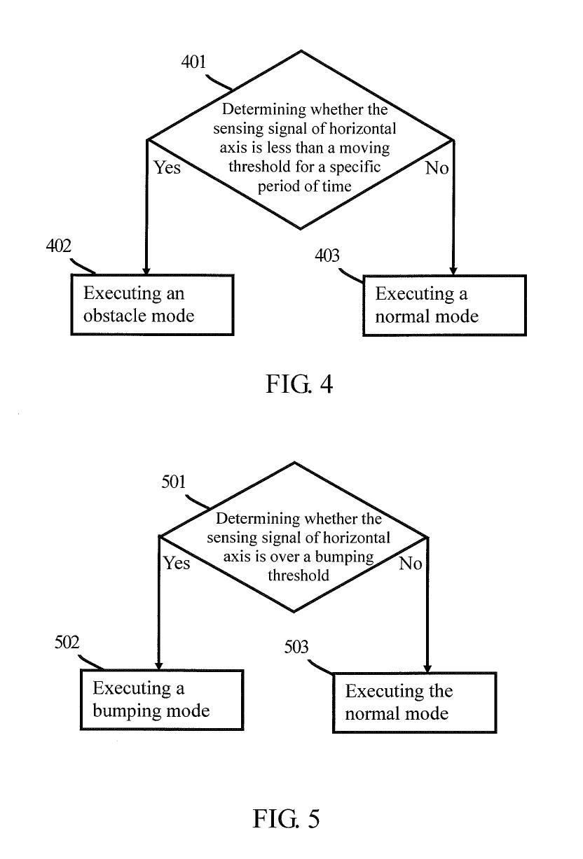

Please refer to FIG. 5, which illustrates a flowchart drawing of the method for adjusting the motor of the autonomous electronic device according to the second embodiment of the present invention.

In the second embodiment, the processing module 11 first executes step 501: Determining whether the sensing signal of the horizontal axis is over a bumping threshold.

According to the sensing signal transferred from the motion sensor module 42, the processing module 11 determines whether the sensing signal of the horizontal axis is over a bumping threshold. The bumping threshold can be the acceleration change value of the autonomous electronic device 10b in normal movement. When the acceleration changing value of the autonomous electronic device 10b is over the bumping threshold, the processing module 11 will determine that the autonomous electronic device 10b has contacted or hit an obstacle.

Therefore, if the sensing signal of horizontal axis is over the bumping threshold, the processing module 11 executes step 502: Executing a bumping mode.

When the autonomous electronic device 10b contacts or hits an obstacle, the sensing signal of the horizontal axis is taken as an abnormal movement signal of bumping; accordingly, the processing module 11 will control the wheel 30 to turn around via the motor 20, such that the autonomous electronic device 10b will avoid the obstacle.

If the sensing signal of the horizontal axis is in the normal range, the processing module 11 executes step 503: Executing the normal mode.

If the sensing signal of the horizontal axis is a normal signal, the processing module 11 will determine that the movement of the autonomous electronic device 10b is normal, and then the autonomous electronic device 10b will execute the normal mode continuously to move normally.

Please refer the FIG. 6, which illustrates a flowchart drawing of the method for adjusting the motor of the autonomous electronic device according to the third embodiment of the present invention.

In the third embodiment, the processing module 11 first executes step 601: Determining whether the feedback signal is over a specific threshold or the sensing signal of the vertical axis is over a vibration threshold.

According to the sensing signal transferred from the motion sensor module 42, the processing module 11 can determine whether the sensing signal of the vertical axis is over a vibration threshold. The vibration threshold can be the vertical axis acceleration change value of the autonomous electronic device 10b in normal movement. On the other hand, according to the feedback signal generated by the motor status detecting module 41, the processing module 11 can determine whether the feedback signal is over a specific threshold. Taking the electric current value of the motor 20 detected by the motor status detecting module 41 as an example, the specific threshold is the electric current threshold, which is the required electric current value for the motor 20 while the autonomous electronic device 10b is in the normal movement status. When the vertical axis acceleration of the autonomous electronic device 10b changes and rises over the vibration threshold, or the electric current value is over than the electric current threshold of normal movement, then it can be determined that the autonomous electronic device 10b is moving on an irregular surface. The irregular surface can be, but is not limited to, a shag-pile carpet.

When the feedback signal is over a specific threshold, or the vertical axis sensing signal is over a vibration threshold, the processing module 11 executes step 602: Executing a vibration mode.

When the processing module 11 determines that the autonomous electronic device 10b is moving on an irregular surface, the vertical axis signal will be taken as an abnormal movement signal of vibration; accordingly, the processing module 11 will control the motor 20 to adapt to the surrounding conditions. Alternatively, if the feedback signal is over the specific threshold of normal movement, the processing module 11 can execute the vibration mode, too. For example, if the autonomous electronic device 10b moves on a shag-pile carpet, the processing module 11 can control the motor 20 to reduce the rotation speed of the wheel 30, to enhance cleaning of the shag-pile carpet.

If the sensing signal of the vertical axis is not over the vibration threshold or the feedback signal is not over the specific threshold, then the processing module 11 executes step 603: Executing the normal mode.

If the sensing signal of vertical axis is normal, or the feedback signal is within the specific threshold, the processing module 11 determines that the autonomous electronic device 10b has not encountered an abnormal surface, so the autonomous electronic device 10b will execute the normal mode continuously to move normally.

It should be noted that the method of controlling the autonomous electronic device is not limited to the abovementioned procedures; the procedures can be changed or switched as long as the objects of the present invention are achievable. The methods of adjusting the motor of the present invention are not limited to the examples above, either; the methods can be adjusted based on the needs of the autonomous electronic device 10a or 10b. The processing module 11 can execute those methods from the first embodiment to the third embodiment in turn, or execute different methods in response to different surrounding conditions. For example, if the autonomous electronic device 10a or 10b moves on a shag-pile carpet and contacts an obstacle, the processing module 11 can execute the obstacle mode and the vibration mode at the same time to achieve the best results for adapting to surrounding conditions.

As in the above description, the structures of the autonomous electronic devices 10a or 10b are simpler than those of the autonomous electronic device of the prior art, and they can flexibly adjust themselves to adapt to the surrounding conditions without the effect of an obstacle height limit. Therefore, the present invention is an improvement upon the prior art.

Although the present invention has been explained in relation to its preferred embodiments, it is to be understood that many other possible modifications and variations can be made without departing from the spirit and scope of the invention as hereinafter claimed.

What is claimed is:

1. An autonomous electronic device comprising:
a wheel;
a motor connected to the wheel for driving the wheel;
a motor controlling module electrically connected to the motor for controlling the motor;
a motion sensor module used for generating a sensing signal according to surrounding conditions encountered by the autonomous electronic device; and
a processing module electrically connected to the motor controlling module and the motion sensor module used for receiving the sensing signal; wherein
when the sensing signal is an abnormal movement signal, the processing module controls the motor via the motor controlling module according to the abnormal movement signal, and further adjusts the wheel to adapt to the surrounding conditions.

2. The autonomous electronic device as claimed in claim 1, wherein the sensing signal comprises a sensing signal of the horizontal axis and a sensing signal of the vertical axis.

3. The autonomous electronic device as claimed in claim 2, wherein the processing module executes a bump mode when the sensing signal of the horizontal axis exceeds a bumping threshold.

4. The autonomous electronic device as claimed in claim 2, wherein the processing module executes an obstacle mode when the sensing signal of the horizontal axis is below a moving threshold for a specific period of time.

5. The autonomous electronic device as claimed in claim 2, wherein the processing module executes a vibration mode when the sensing signal of the vertical axis exceeds a vibration threshold.

6. The autonomous electronic device as claimed in claim 1, further comprising a motor status detecting module that is electrically connected to the motor and the motor controlling module used for detecting a status of the motor to obtain a feedback signal, wherein the processing module is used for receiving the feedback signal and further controls the motor via the motor controlling module according to the feedback signal to adapt to the surrounding conditions when the feedback signal is abnormal.

7. The autonomous electronic device as claimed in claim 6, wherein the processing module executes a vibration mode when the feedback signal exceeds a specific threshold.

8. The autonomous electronic device as claimed in claim 7, wherein the motor status detecting module is an electric current sensor module used for detecting an electric current value of the motor, and the specific threshold is an electric current threshold.

9. The autonomous electronic device as claimed in claim 1, wherein the motion sensor module is an accelerometer.

10. The autonomous electronic device as claimed in claim 1, wherein the motion sensor module is used for detecting the sensing signal after the motor actuates.

11. A method of controlling a motion of an autonomous electronic device used for the autonomous electronic device, the autonomous electronic device comprising a motor and a wheel, and the method comprising:
detecting a sensing signal via a motion sensor module according to a surrounding condition encountered by the autonomous electronic device;
determining whether the sensing signal is an abnormal movement signal; and
if yes, controlling the motor according to the abnormal movement signal and further adjusting the wheel to adapt to the surrounding conditions.

12. The method of controlling the motion of the autonomous electronic device as claimed in claim 11, wherein the step of detecting the sensing signal comprises detecting a sensing signal of the horizontal axis.

13. The method of controlling the motion of the autonomous electronic device as claimed in claim 12, wherein the step of determining whether the sensing signal is one of abnormal movement further comprising:
determining whether the sensing signal of horizontal axis exceeds a bumping threshold; and
if yes, executing a bump mode.

14. The method of controlling the motion of the autonomous electronic device as claimed in claim 12, wherein the step of determining whether the sensing signal is one of abnormal movement further comprising:
determining whether the sensing signal of horizontal axis is below a moving threshold for a specific period of time; and
if yes, executing an obstacle mode.

15. The method of controlling the motion of the autonomous electronic device as claimed in claim 11, wherein the step of detecting the sensing signal comprises detecting a sensing signal of the vertical axis.

16. The method of controlling a motion of the autonomous electronic device as claimed in claim 15, wherein the step of determining whether the sensing signal is the abnormal movement further comprises:
determining whether the sensing signal of the vertical axis exceeds a vibration threshold; and
if yes, executing a vibration mode.

17. The method of controlling the motion of the autonomous electronic device as claimed in claim 11, the method further comprising:
detecting a status of the motor via a motor sensor module to obtain a feedback signal;
determining whether the feedback signal is abnormal; and
if yes, further controlling the motor according to the feedback signal to adjust the wheel to adapt to the surrounding conditions.

18. The method of controlling the motion of the autonomous electronic device as claimed in claim 17, wherein the step of determining whether the feedback signal is abnormal further comprises:
determining whether the feedback signal is over a specific threshold; and
if yes, executing a vibration mode.

19. The method of controlling the motion of the autonomous electronic device as claimed in claim 18, wherein the step of detecting the status of the motor comprises detecting an electric current value of the motor via an electric current sensor module, and the specific threshold is the electric current threshold.

20. The method of controlling the motion of the autonomous electronic device as claimed in claim 11, the method further comprising:
actuating the motor in advance to drive the wheel.
